(19) United States
(12) Patent Application Publication
(10) Pub. No.: US 2005/0047989 A1
(43) Pub. Date: Mar. 3, 2005

(54) Thermally treated polycrystalline diamond (PCD) and polycrystalline diamond compact (PDC) material

(76) Inventor: Daniel Watson, Driftwood, TX (US)

Correspondence Address: BUSKOP LAW GROUP, P.C., 1717 ST. JAMES PLACE, SUITE 500, HOUSTON, TX, 77056, US

(21) Appl. No.: 10/783,933

(22) Filed: Feb. 20, 2004

Related U.S. Application Data
(60) Provisional application No. 60/497,624, filed on Aug. 25, 2003.

(51) Int. Cl. C01B 31/06

(52) U.S. Cl. 423/446

(57) ABSTRACT

The toughened material is a diamond material of a substantially continuous matrix and a material with a degree of ductility that is greater than that of granules dispersed within the continuous matrix; wherein the toughened material is formed by placing a diamond material into a chamber of a thermal control apparatus; introducing a cryogenic material into the thermal control apparatus; decreasing the material temperature in the chamber with the cryogenic material while preventing over-stressing of the diamond material to a first target temperature ranging from −40 degrees F. to −380 degrees F. at a first temperature rate; stopping the introduction of the cryogenic material into the chamber once the first target temperature is reached; increasing the material temperature to the second target temperature ranging from 0 degrees F. to 1400 degrees F. at a second temperature rate resulting in a toughened diamond material.

The present application claims priority to co-pending U.S. Provisional Patent Application Ser. No. 60/497,624 filed on Aug. 25, 2003.

### FIELD

The present embodiments relate to thermal processes for treating a polycrystalline diamond and polycrystalline diamond compact material (PCD/PDC) to improve its structural characteristics.

### BACKGROUND

A need exists for a process to treat polycrystalline diamonds and similar materials of manufacture in order to increase their structural characteristics. For example, in the manufacture of drilling equipment, tools and tool components, machinery, engine parts, wear surfaces and like articles from various steels and materials that are used for high wear applications, the common practice is to subject the steel to one or more thermal process treatments, either before or after formation of the PDC/PCD, so as to modify the properties of at least the exterior of the components. These treatments provide the articles with a longer wear life and the like.

A number of thermal type processes are known in the material engineering arts to enhance the properties of manufacturing materials, such as carbon based cutters, and the like. One widely used class of such material processes generally known as quenching typically involves forming an article of the desired material and then rapidly lowering the temperature of the article followed by a return of the article to ambient temperature. The problem with the current processes is that they are usually uncontrolled and result in over-stressing the material and even fracturing the material rendering it useless.

A need has long existed for PDC/PCD based drilling equipment that is stronger, less brittle and tougher than known materials.

A process has long been needed to provide improved polycrystalline diamond products that have enhanced structural characteristics.

### SUMMARY

The present embodiments relate to a toughened material having a diamond material. The diamond material is a natural diamond, a synthetic diamond, a polycrystalline diamond, or mixtures thereof. The diamond material is a substantially continuous matrix comprising a material having a degree of ductility that is greater than that of granules dispersed within the continuous matrix.

Toughened material is formed by placing the diamond material within a thermal control apparatus. The thermal control apparatus has a chamber, wherein the chamber temperature is closely regulated. A first cryogenic material is introduced into the thermal control apparatus decreasing the material temperature while preventing over-stressing of the diamond material. The temperature of the diamond material is reduced to a first target temperature ranging from −40 degrees F. and −380 degrees F. at a first temperature rate ranging from 0.25 degrees F. per minute and 20 degrees F. per minute. When the first target temperature is reached, the cryogenic material is no longer introduced into the chamber. The chamber temperature is, then, increased to a second target temperature ranging from 0 degrees F. and 1400 degrees F. at a second temperature rate ranging from 0.25 degrees F. per minute and 20 degrees F. per minute. The result is a toughened diamond material.

### BRIEF DESCRIPTION OF THE DRAWINGS

The present embodiments will be explained in greater detail with reference to the appended Figures, in which:

FIG. 1 is a diagram of the steps of the method for treating a polycrystalline diamond according to the invention;

FIG. 2 depicts a cross section of the chamber used in the inventive method; and

FIG. 3 is a diagram of the steps of producing a polycrystalline diamond by a thermal process using three thermal cycles.

The present embodiments are detailed below with reference to the listed Figures.

### DETAILED DESCRIPTION OF THE PREFERRED EMBODIMENTS

Before explaining the present embodiments in detail, it is to be understood that the embodiments are not limited to the particular embodiments herein and it can be practiced or carried out in various ways.

The present invention is toughened material having a diamond material.

The diamond material is a natural diamond, a synthetic diamond, a polycrystalline diamond, or and mixtures thereof. The diamond material is a substantially continuous matrix with a material having a degree of ductility that is greater than that of granules dispersed within the continuous matrix.

The toughened material is formed by the steps comprising

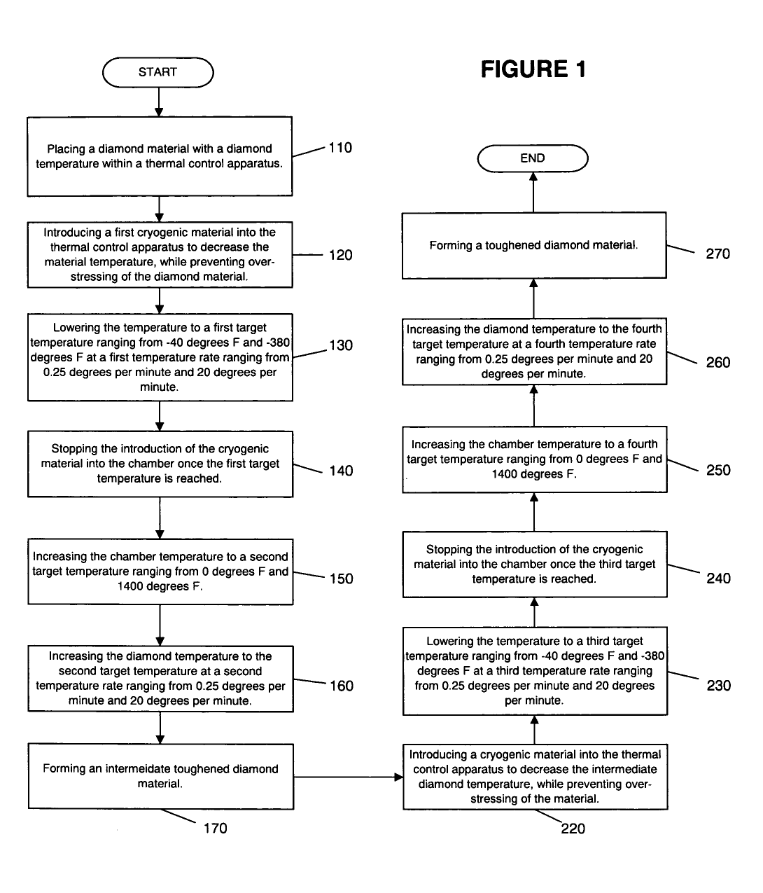

FIG. 1 provides the steps of producing thermally treated toughened material by a thermal process. The toughened material is made by placing a diamond material within a thermal control apparatus (110). The diamond material itself has a material temperature. The thermal control apparatus has a chamber that has a chamber temperature.

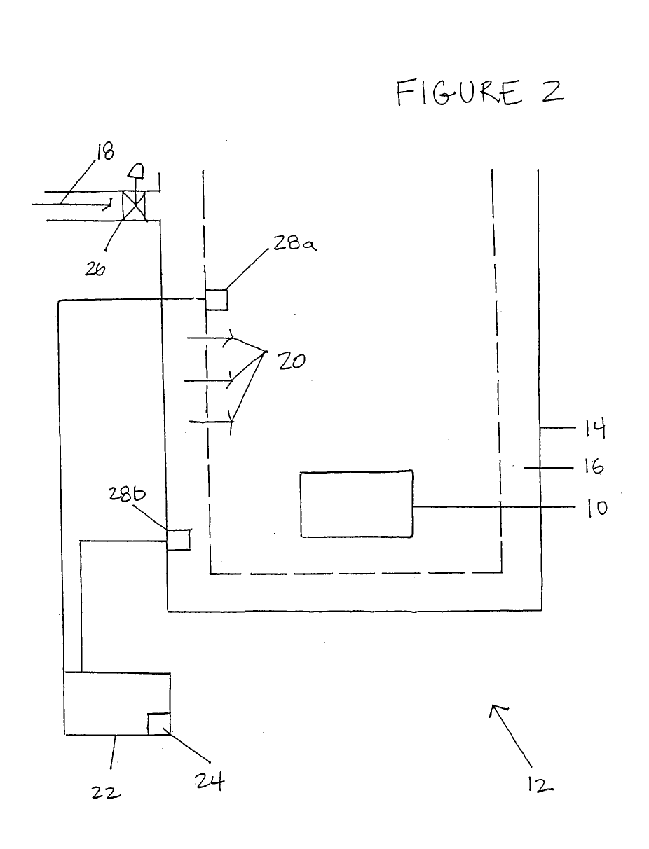

FIG. 2 depicts a cross sectional view of the thermal control apparatus (12) that comprises a chamber (14). The PDC/PCD (10) is placed within the chamber (14). In the embodiment of FIG. 2, cryogenic material (18) is introduced to the thermal control apparatus (12), such as through a valve (26) such that the temperature of the chamber (14) increases or deceases depending on whether the valve (26) is on or off. The temperature of the chamber (14) is closely regulated.

The thermal control apparatus (12) can further include a heat exchanger (16) located within the chamber (14) to provide a cryogenic vapor (20) to the chamber (14). The cryogenic material (18) is released into the heat exchanger (16) thereby absorbing heat from the chamber (14) into the heat exchanger (16) forming a cryogenic vapor (20) that fills the chamber (14). Examples of cryogenic vapors contemplated in this invention are hydrogen, nitrogen, oxygen, helium, argon, and combinations thereof.

The chamber used in the thermal process can be a double-walled insulated chamber, a vacuum chamber, and a vacuum-insulated chamber. Computer control (22) of the cryogenic process consists of a dedicated microprocessor unit (24) that controls injection of the cryogenic material (18) via a solenoid-operated valve (26). Thermocouples (28a and 28b) provide real-time temperature measurement, and feedback to the microprocessor (24), which then follows the programmed temperature targets and rates.

Continuing with FIG. 1, a first cryogenic material is introduced into the thermal control apparatus in order to decrease the material temperature (120). The cryogenic material is added so that the diamond material is not over-stressed. Over-stressing includes fracturing the diamond material. The temperature of the PDC/PCD is decreased to a first target temperature ranging from −40 degrees F. to −380 degrees F. The temperature is decreased at a first temperature rate ranging from 0.25 degrees F. per minute to 20 degrees F. per minute (130). Once the first target temperature is reached, the cryogenic material is no longer added to the chamber (140).

The method continues by increasing the chamber temperature to a second target temperature ranging from 0 degrees F. to 1400 degrees F. (150). The material temperature is also increased to the second target temperature at a second temperature rate (160). The second temperature rate ranges from 0.25 degrees F. per minute to 20 degrees F. per minute. The result is an intermediate toughened diamond material (170).

Optionally, it should be noted that the diamond material can be permitted to soak at the second target temperature for a period of time that ranges from 15 minutes to 48 hours. It is contemplated that the soaking at the second temperature can vary from less than 15 minutes to about 1 minute and up to 2 weeks. It is noted that the preferred aging process at the elevated temperature may be as short as 4 days to relieve the stress in the diamond material.

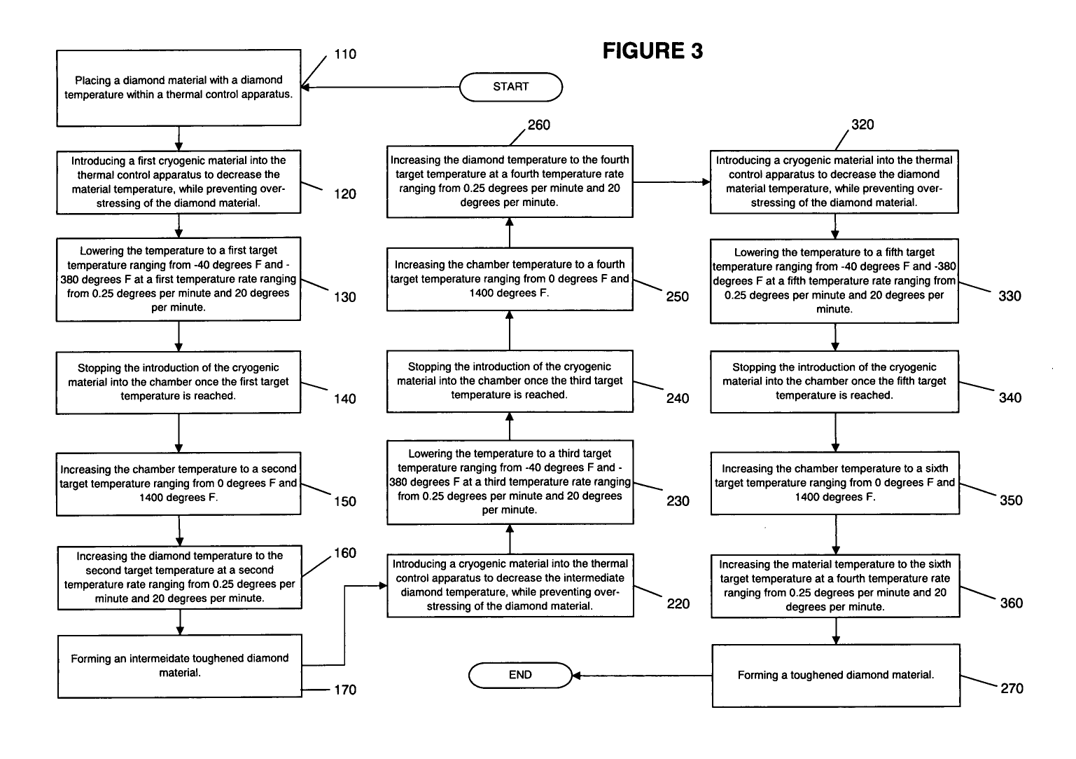

The invention also contemplates that the diamond material can be subjected to a second thermal cycle as shown in FIG. 3. In the second thermal cycle a second cryogenic material, which may differ from the first cryogenic material, is introduced into the thermal control apparatus decreasing the intermediate material temperature while preventing over-stressing of the toughened diamond material (220). The temperature is reduced to a third target temperature ranging from −40 degrees F. to −380 degrees F. at a third temperature rate ranging from 0.25 degrees F. per minute to 20 degrees F. per minute (230). The method continues by stopping the introduction of the cryogenic material into the chamber once the third target temperature is reached (240).

The chamber temperature is, then, increased to a fourth target temperature ranging from 0 degrees F. to 1400 degrees F. (250). The intermediate material temperature is, thereby, also increased to the fourth target temperature at a fourth temperature rate (260). The fourth temperature rate ranges from 0.25 degrees F. per minute to 20 degrees F. per minute. The result is a toughened diamond material (270).

Like the end of the first cycle, the toughened diamond material can be permitted to soak at the fourth target temperature for a period of time that ranges from 15 minutes to 48 hours. It is contemplated that the soaking at the fourth temperature can vary from less than 15 minutes to about 1 minute and up to 2 weeks. It is noted that the preferred aging process at the elevated temperature may be as short as 4 days to relieve the stress in the diamond material.

In an alternative embodiment, the PDC/PCD can be further treated by a third cycle. FIG. 3 depicts steps of producing a thermally treated PDC/PCD using three thermal cycles the process resulting in a toughened diamond material without fractures and improved structural and material characteristics.

In the third cycle, the cryogenic material is added to the thermal control apparatus to decrease the material temperature while preventing over-stressing of the diamond material (320). The material temperature is reduced to a fifth target temperature ranging from −40 degrees F. to −380 degrees F. at a fifth temperature rate (330). The fifth temperature rate ranges from 0.25 degrees F. per minute to 20 degrees F. per minute. When the fifth target temperature is reached, the cryogenic material is no longer introduced into the chamber (340).

The third cycle continues by increasing the chamber temperature to a sixth target temperature and, thereby, increasing the material temperature to the sixth target temperature ranging from 0 degrees F. to 1400 degrees F. (350). The temperature increase is done at a sixth temperature rate ranging from 0.25 degrees F. per minute to 20 degrees F. per minute (360) resulting in a toughened material without fractures and improved structural and material characteristics (270).

The temperature rates in each cycle are determined by the mass of the diamond material.

The diamond material can be a heat treated material that has been heated to a temperature of at least 180 degrees F. and cooled.

The invention contemplates that the diamond material is a laminate. The laminate is the diamond member disposed can be a ceramic, a paper, a woven fiber, a non woven fiber, a polymer, or combinations thereof. The diamond material has a crystalline structure and can be bonded with a second material. Examples of second materials the diamond can be bonded to include iron, iron alloy, copper, copper alloy, carbide, ceramet, and combinations thereof. In addition, the polycrystalline diamond can be a coating.

The most preferred embodiment of the invention is three thermal cycles of cryogenic treatment with a double heat treatment at the end. The first target temperature is known as the shallow chill. The third target temperature is known as the cold chill. A “heat” process is when the PDC/PCD temperature is allowed to return to room temperature or anything above 0 degrees F. “Aging” is defined as holding at room temperature for several days or weeks between chills. Aging is also effective when used in combinations with this thermal process.

While these embodiments have been described with emphasis on the preferred embodiments, it should be understood that within the scope of the appended claims the embodiments might be practiced other than as specifically described herein.

1. A toughened material having a diamond material comprising:
a. a diamond material selected from the group consisting of a natural diamond, a synthetic diamond, a polycrystalline diamond, and mixtures thereof;
i. wherein the diamond material is a substantially continuous matrix comprising a material having a degree of ductility that is greater than that of granules dispersed within the continuous matrix; and
ii. wherein the diamond material has a material temperature;
b. wherein the toughened material is formed by the steps comprising:
i. placing a diamond material into a chamber of a thermal control apparatus wherein the chamber has a chamber temperature;
ii. introducing a first cryogenic material into the thermal control apparatus;
iii. decreasing the material temperature in the chamber with the first cryogenic material while preventing over-stressing of the diamond material to a first target temperature ranging from −40 degrees F. to −380 degrees F. at a first temperature rate ranging from 0.25 degrees per minute to 20 degrees per minute;
iv. stopping the introduction of the first cryogenic material into the chamber once the first target temperature is reached;
v. increasing the chamber temperature to a second target temperature ranging from 0 degrees F. to 1400 degrees F.; and
vi. increasing the material temperature to the second target temperature at a second temperature rate ranging from 0.25 degrees per minute to 20 degrees per minute resulting in a toughened diamond material.

2. The toughened material of claim 1, further comprising the step of treating the toughened diamond material by the steps comprising:
a. introducing a second cryogenic material into the thermal control apparatus to decreasing the toughened diamond material temperature and while preventing over-stressing of the toughened diamond material, to a third target temperature ranging from −40 degrees F. to −380 degrees F. at a third temperature rate ranging from 0.25 degrees per minute to 20 degrees per minute;
b. stopping the introduction of the second cryogenic material into the chamber once the third target temperature is reached;
c. increasing the chamber temperature to a fourth target temperature from 0 degrees F. to 1400 degrees F.; and
d. increasing the toughened diamond material temperature to the fourth target temperature at a fourth temperature rate ranging from 0.25 degrees per minute to 20 degrees per minute.

3. The toughened material of claim 1, wherein the diamond material is treated using the first temperature rate substantially the same as the second temperature rate.

4. The toughened material of claim 2, wherein the diamond material is treated further using the steps of:
a. introducing a third cryogenic material into the thermal control apparatus to decreasing the diamond material temperature and while preventing over-stressing of the diamond material, to a fifth target temperature ranging from −40 degrees F. to −380 degrees F. at a fifth temperature rate ranging from 0.25 degrees per minute to 20 degrees per minute;
b. stopping the introduction of the third cryogenic material into the chamber once the fifth target temperature is reached;
c. increasing the chamber temperature to a sixth target temperature from 0 degrees F. to 1400 degrees F.; and
d. increasing the diamond material temperature to the sixth target temperature at a sixth temperature rate ranging from 0.25 degrees per minute to 20 degrees per minute resulting in the toughened diamond.

5. The toughened material of claim 1, further comprising the step of permitting the diamond material to soak at the first target temperature for a first period of time.

6. The toughened material of claim 5, wherein the first period of time ranges from 15 minutes to 96 hours.

7. The toughened material of claim 1, further comprising the step of permitting the diamond material to soak at the second target temperature for a second period of time.

8. The toughened material of claim 7, wherein the second period of time ranges from 15 minutes to up to 48 hours.

9. The material of claim 1, wherein the thermal control apparatus further comprises a heat exchanger disposed in the chamber to provide a cryogenic vapor to the chamber.

10. The material of claim 9, wherein the cryogenic material is released into the heat exchanger thereby absorbing heat from the chamber into the heat exchanger forming the cryogenic vapor that fills the chamber.

11. The material of claim 9, wherein the cryogenic vapor is a member of the group consisting of hydrogen, nitrogen, oxygen, helium, argon, and combinations thereof.

12. The toughened material of claim 1, wherein the first temperature rate and the second temperature rate are determined by the mass of the diamond material.

13. The toughened material of claim 2, wherein the third temperature rate and the fourth temperature rate and are determined by the mass of the diamond material.

14. The toughened material of claim 4, wherein the fifth temperature rate and the sixth temperature rate and are determined by the mass of the diamond material.

15. The toughened material of claim 1, wherein the diamond material is a laminate.

16. The toughened material of claim 15, wherein the laminate is the diamond member disposed on a member of the group consisting of a ceramic, a paper, a woven fiber, a non woven fiber, a polymer, and combinations thereof.

17. The toughened material of claim 1, wherein the diamond material has a crystalline structure.

18. The toughened material of claim 1, wherein the diamond material is bonded with a second material.

19. The toughened material of claim 18, wherein the second material is selected from the group consisting of an iron, an iron alloy, a copper, a copper alloy, a carbide, a ceramet, and combinations thereof.

20. The toughened material of claim 1, wherein the polycrystalline diamond is a coating.

21. The toughened material of claim 1, wherein the diamond material is a heat treated material.

22. The toughened material of claim 21, wherein the heat treated material is a diamond material that has been heated to a temperature of at least 180 degrees F. and cooled.
